(19) United States
(12) Patent Application Publication
(10) Pub. No.: US 2012/0054495 A1
(43) Pub. Date: Mar. 1, 2012

(54) DATA TRANSMISSION PROCESSING DEVICE AND DATA TRANSMISSION PROGRAM

(75) Inventors: Toshinari TAKAHASHI, Tokyo (JP); Shinji YAMANAKA, Tokyo (JP); Yuichi KOMANO, Kanagawa (JP)

(73) Assignee: KABUSHIKI KAISHA TOSHIBA, Tokyo (JP)

(21) Appl. No.: 13/197,436

(22) Filed: Aug. 3, 2011

(30) Foreign Application Priority Data
Aug. 27, 2010 (JP) P2010-191339

(51) Int. Cl. G06F 15/16; H04L 9/32

(52) U.S. Cl. 713/176; 709/246

(57) ABSTRACT

According to one embodiment, there is provided a data transmission processing device, including: a identifying portion configured to identify a module having sent out data; a storage portion configured to store a sending-out method definition list defined in accordance with each source module and indicating a processing method for the data, the processing method including a data conversion method or permission/prohibition of communication; a determining portion configured to determine a processing method corresponding to the source module identified by the identifying portion by referring to the sending-out method definition list; a converting portion configured to convert the data when the data conversion method is included in the processing method determined by the determining portion; and a transmission portion configured to send out the data or the converted data when the determining portion concludes that communication is permitted.

### CROSS-REFERENCE TO RELATED APPLICATION(S)

This application claims priority from Japanese Patent Application No. 2010-191339 filed on Aug. 27, 2010, the entire contents of which are incorporated herein by reference.

### FIELD

Embodiments described herein relate generally to a data transmission.

### BACKGROUND

Two authentication methods have been heretofore often used as modes of authentication for communication between devices or programs connected to one another by a communication line. For example, there are used a device authentication method (A) which allows a communication device to have an authentication function, a module authentication method (B) which allows each module to have authentication function.

In the device authentication method (A), the subject of authentication is used as one individual even in the case where plural modules are mounted in one device. In a network computer implemented with an Internet protocol (IP), each device having one IP address is regarded as one individual so that an authenticator created based on a secret key corresponding to the device is added to an IP packet before the IP packet is transmitted. Authentication using an ID number (MAC address) unique to each network interface, authentication based on an encryption technique represented by IPsec (Security Architecture for Internet Protocol), VPN (Virtual Private Network) using an applied encryption technique, etc. have come into wide use as authentications belonging to the device authentication method.

In the module authentication method (B), each module has an authentication ID or key individually so that an authentication algorithm using the authentication ID or key is implemented into the module to thereby allow the module to perform authentication with a communication partner regardless of the IP address, etc. In the module authentication method, various encryption techniques, etc. can be used without method limitation because any authentication method can be generally executed as a program. For example, an SSH (Secure SHell) protocol, etc. may be used.

These authentication methods according to the related art are used for communication between industrial devices having limited functions or in Internet applications in general-purpose PC's (personal computers), etc.

In accordance with the popularization of a communication network needs to be authenticated, sometimes, in a network device authentication device according to the related art, functions having different rights are mixed. When a device complicated in terms of use mode, misinformation transmitted from a transmission portion because of mistaken data processing, etc. in an application may hinder the original authentication function of the authentication device from working effectively or it is difficult to prevent an illegally invading computer virus from sending illegal data into the transmission portion. Thus, the security of a device in which functions having different rights are mixed may be decreased.

When an independent authentication function is provided for each function, implementation is complicated. Thus, it is still difficult to maintain the system security of the device.

### BRIEF DESCRIPTION OF THE DRAWINGS

FIG. 1 illustrates a system configuration according to a first embodiment.

FIG. 2 illustrates an operation flow of the system according to the first embodiment.

FIG. 3 illustrates a sending-out method definition list according to the first embodiment.

FIG. 4 illustrates reception data and transmission data according to the first embodiment.

FIG. 5 illustrates a system configuration according to a second embodiment.

FIG. 6 illustrates a system configuration according to a third embodiment.

FIG. 7 illustrates a sending-out method definition list according to a fourth embodiment.

FIG. 8 illustrates reception data and transmission data according to the fourth embodiment.

FIG. 9 partially illustrates a system configuration according to a fifth embodiment.

FIG. 10 illustrates each process table according to a sixth embodiment.

FIG. 11 illustrates a sending-out method definition list according to the sixth embodiment.

FIG. 12 illustrates an application example of the embodiments.

### DETAILED DESCRIPTION

According to one embodiment, there is provided a data transmission processing device, including: a data receiving portion configured to receive data; a source module identifying portion configured to identify a module having sent out the data; a sending-out method definition list storage portion configured to store a sending-out method definition list defined in accordance with each source module and indicating a processing method for the data, the processing method including a data conversion method or permission/prohibition of communication; a processing method determining portion configured to determine a processing method corresponding to the source module identified by the source module identifying portion by referring to the sending-out method definition list; a data converting portion configured to convert the data when the data conversion method is included in the processing method determined by the processing method determining portion; and a transmission portion configured to send out the data or the converted data when the processing method determining portion concludes that communication is permitted.

### First Embodiment

A first embodiment will be described below in detail with reference to the drawings.

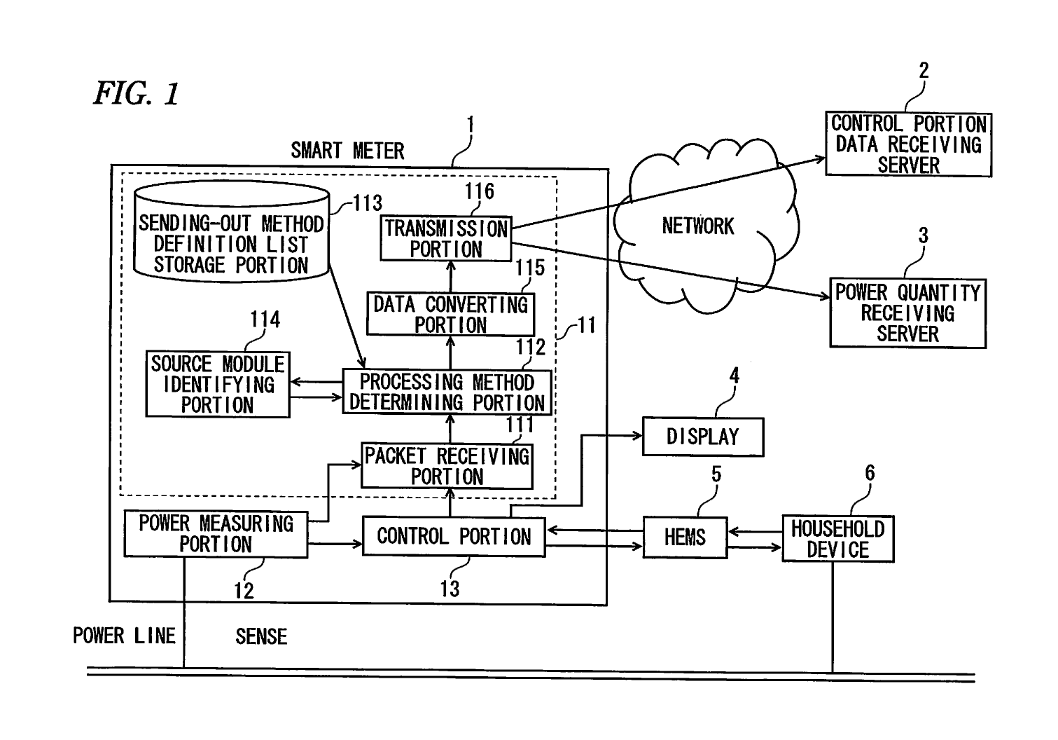

FIG. 1 illustrates a system configuration of a data transmission system according to the embodiment and devices which work with the system. A layout example of a set of power monitoring devices connected through a public network such as Internet and functional blocks of the power monitoring devices are shown in FIG. 1.

The data transmission system according to the embodiment has a smart meter 1, a control portion data receiving server 2, and a power quantity receiving server 3. The data transmission system according to the embodiment is connected to a display 4 and an HEMS (Home Energy Management System: home server) 5. The HEMS 5 is connected to a household device 6.

The smart meter 1 is an electric power meter provided in a power consumption point (end user) such as an ordinary home, a building or a factory. The smart meter 1 has a function of connecting the smart meter 1 to a network.

The smart meter 1 has a power measuring portion 12, a control portion 13, a packet receiving portion 111, a processing method determining portion 112, a sending-out method definition list storage portion 113, a source module identifying portion 114, a data converting portion 115, and a transmission portion 116. A portion including the packet receiving portion 111, the processing method determining portion 112, the source module identifying portion 114, the sending-out method definition list storage portion 113, the data converting portion 115 and the transmission portion 116 is referred to as transmission processing portion 11 (transmission processing device). Incidentally, the smart meter 1 can have various functional modules concerned with control of a power network. In the embodiment, description is simplified and other functional modules may be provided in the smart meter 1.

The term “module” herein used means one process (processing unit). Although a module is typically a subject (process) to be executed by a computer, a module may be regarded as a file (‘exe’ file) in which a program is stored, or as an implemented function (such as a common library or a ‘dll’ file) as occasion demands. Alternatively, a module may be a program implemented by software or a hardware module having a certain implemented function.

The power measuring portion 12 exclusively handles important data such as consumed power quantity. The power measuring portion 12 is connected to a power line to measure the power quantity of each device connected to the power line. For example, in FIG. 1, the household device 6 is connected to the power line, so that the power measuring portion 12 measures the power quantity of the household device 6. However, the embodiment is not limited thereto. The power measuring portion 12 can measure the power quantity of any device as long as the device is connected to the power line. In addition, the power measuring portion 12 transmits data (packet) including the measured power quantity to the control portion 13 and the packet receiving portion 111 which will be described later.

The control portion 13 handles miscellaneous data such as control of the household device 6 in a home and display of power consumption. The control portion 13 receives data from the power measuring portion 12. The control portion 13 may perform control of a display function on the display 4 disposed in the home or may perform control of the HEMS 5 through data exchange with the HEMS 5 which works with the household device 6. Since there is no difference from the related art with respect to the data exchange, detailed description and illustration thereof will be omitted. The control portion 13 transmits data (packet) handled by the control portion 13 to the packet receiving portion 111 which will be described later.

The HEMS 5 is not only connected to the control portion 13 but also connected to the household device 6. The HEMS 5 may use information held by the HEMS 5 to control the household device 6 or obtain information from the household device 6.

Although the power measuring portion 12 and the control portion are basically independent of each other, it may be conceived that part of data measured by the power measuring portion 12 is handed over to the control portion 13 and processed by the control portion 13 as the system demands.

The packet receiving portion 111 transmits received data (packet) to the processing method determining portion 112 which will be described later.

Upon reception of data (packet) from the packet receiving portion 111, the processing method determining portion 112 transmits the data (packet) to the source module identifying portion 114 which will be described later, so that the processing method determining portion 112 obtains identification information of a source module having sent out the received data (packet). Here, the identification information of the source module is information for identifying a source module having sent out the data (packet). In the example of the embodiment, the identification information of the source module is a name etc. indicating a module of the power measuring portion 12 or the control portion 13. However, the information is not limited thereto as long as the source module having sent out the data (packet) can be identified by the information.

By checking the identification information of the source module having sent out the data (packet) and information about the processing method described in the sending-out method definition list while using the identification information of the source module as a key, the processing method determining portion 112 determines a packet processing method (determines a processing method corresponding to the source module by referring to the sending-out method definition list). The processing method determining portion 112 sends out the data (packet) when communication is permitted. If necessary, the processing method determining portion 112 also sends out the processing method (processing method information) and the key to the data converting portion 115 which will be described later.

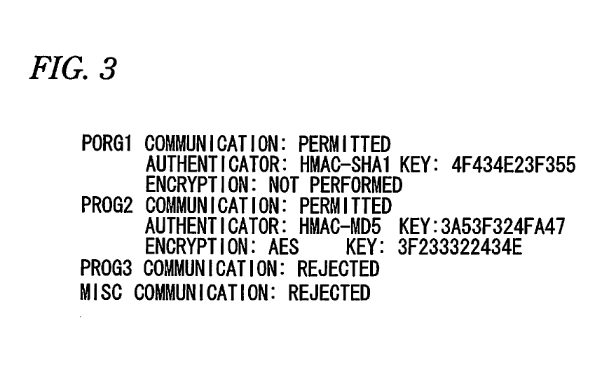

The sending-out method definition list storage portion 113 stores a sending-out method definition list. The sending-out method definition list has information about correspondence between identification information of a source module and permission/prohibition of communication, or information about correspondence between identification information of the source module and a data conversion method (has information indicating a processing method for the data, which method is defined in accordance with each source module and includes a data conversion method or permission/prohibition of communication). For example, the sending-out method definition list has information indicating permission to send out one packet, and prohibition from sending out another packet. In addition, a packet permitted to be sent out may be sent out after an authenticator is added to the packet or after the packet is encrypted. Rules of these data conversion methods are described in the sending-out method definition list. In addition, a “key” required for creation of an authenticator or encryption is also held in the sending-out method definition list. Here, the term “key” broadly means a general key used in general encryption technology but whether the key is a secret key or a public key is not limited particularly. FIG. 3 illustrates the sending-out method definition list. In the example of FIG. 3, sending-out methods for Prog1, Prog2, Prog3 and Misc are defined. Details will be described below.

Prog1 is the name of a program module of the power measuring portion 12.

Communication is permitted, so that communication for data from the program module of the power measuring portion 12 is permitted. In addition, the authenticator is hmac-shat, so that an authenticator created by an hmac-sha1 algorithm is added to a packet when the packet is transferred.

Since hmac-sha1 is a known authenticator creating method having a key application method hmac combined with a hash function sha1, description about the procedure of hmac-sha1 is omitted. In addition, a key 4f434e23f355 is used in application of hmac-sha1. Although it is usual that a longer key is practically used from the viewpoint of security, a short key is written (the same thing applies hereinafter) for the sake of simplification of description.

In addition, encryption is not performed, so that the packet is not encrypted. Here, the power quantity receiving server 3 also holds the same key. Therefore, the power quantity receiving server 3 can authenticate that this packet is a packet transmitted from the module (power measuring portion 12) of the smart meter 1 because the value of the authenticator calculated by use of the key and the hmac-sha1 algorithm is the same as the value of the authenticator added to the packet.

In this example, description is made in the case where Prog1 is provided so that the packet is not encrypted. This is because the embodiment takes the stance that it does not matter even if data measured by the power measuring portion 12 is intercepted. It is a matter of course that there may be conceived a method which takes measures to encrypt a packet or perform packet filtering to prevent the packet from being sent out to a wrong server in accordance with necessity. Since an ordinary technique can be used, description about this will not be made particularly in the embodiment.

On the other hand, Prog2 is the name of a program module of the control portion 13. Communication is permitted, so that communication for data from the control portion 13 is permitted. In addition, the authenticator is hmac-md5, so that an authenticator created by an hmac-md5 algorithm is added to a packet when the packet is transferred. On this occasion, a key 3a53f324fa47 is used. Since hmac-md5 is also a known authenticator creating method, description about the procedure of hmac-md5 will be omitted here. Further, a packet is encrypted by use of an encryption algorithm AES and a key 3f233322434e. Since handling of the encryption key is not a prerequisite as the core of the embodiment, illustration of the encryption key is omitted in FIG. 1 showing the outline of the embodiment. There is not any particular limitation to the sequence of the encryption process and the authenticator adding process. Encryption may be performed first in accordance with the system. In this case, the sequence described in the sending-out method definition list need to be reversed.

In addition, Prog3 is one name of a program module of an ordinary library. Communication is rejected, which means that communication for a packet from the ordinary library is rejected.

In addition, Misc indicates a program module which has not been put into the list yet. Communication is rejected, which means that communication for data from all program modules whose names are not shown on the list is rejected.

Although information showing a process and a processing method in accordance with each line is described thus in the example of FIG. 3, the information is not limited to this example and may be expressed by any other method as long as the processing method (processing contents) can be identified.

Upon reception of data (packet) from the processing method determining portion 112, the source module identifying portion 114 identifies a packet-sending source module based on packet-sending source module information in which identification information of the packet and identification information of the packet-sending source module are associated with each other. Then, the source module identifying portion 114 sends out the identification information of the source module to the processing method determining portion 112. The identification information of the packet is information for identifying the packet. The identification information of the packet may be one piece of information or a combination of pieces of information.

An example of a method for finding out a packet-sending source module will be described. For example, in the case where data received by the packet receiving portion 111 is an IPv4 TCP packet, the packet has a structure based on IPv4 (Internet Protocol version 4) provided in RFC791 and TCP (Transmission Control Protocol) provided in RFC793. It is therefore possible to find information about Destination Address (Source IP Address), Source Port (Source Port Number), Destination Port (Destination Port Number) etc. by referring to the data.

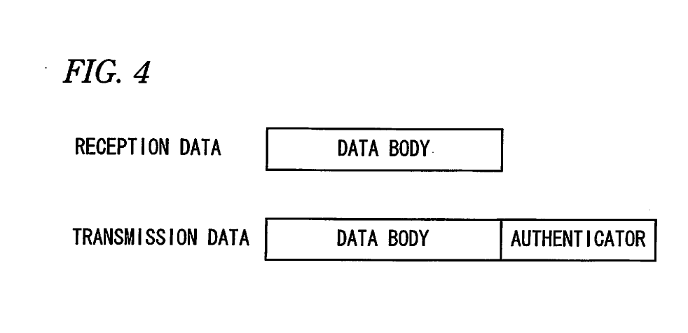

Upon reception of data (packet) and a processing method (processing method information) from the processing method determining portion 112, the data converting portion 115 performs conversion processing on the data (packet) in accordance with the processing method (converts the data in the case where a conversion method for converting the data is included in the processing method determined by the processing method determining portion 112). Encryption, addition of an authenticator, etc. are performed as the conversion processing. Then, the data converting portion 115 sends out the converted data (packet) to the transmission portion. When, for example, the source module for sending out the data (packet) is Prog1 in the example of FIG. 3, the data converting portion 115 creates an authenticator based on the hmac-sha1 algorithm and the key 4f434e23f355. Therefore, the data (packet) is converted so that the authenticator is added to the data (packet) as shown in FIG. 4. For example, an extended data field of IP can be used for addition of the authenticator. The extended data field of IP is also used in the related art such as IPsec.

The transmission portion 116 receives data (packet) converted by the data converting portion and transmits the received data (packet) to the outside of the smart meter 1. In the embodiment, the transmission portion 116 transmits the data (packet) to the control portion data receiving server 2 or the power quantity receiving server 3. On this occasion, switching occurs in such a manner that the data (packet) from the power measuring portion 12 is sent to the power quantity receiving server 3 and the data (packet) from the control portion 13 is sent to the control portion data receiving server 2. Switching has been heretofore performed based on Destination Address (Destination IP Address) written in the packet in the ordinary IP (Internet Protocol) technique. This switching can be also carried out in the embodiment.

In the real system, such variations that servers to which data are allowed to be transmitted are limited in accordance with respective program modules or data conversion methods can be changed in accordance with destinations can be conceived to enhance security. These variations can be achieved easily by simple combination of packet filtering techniques generally called Firewall. Therefore, illustration of these variations will be omitted.

The control portion data receiving server 2 receives data (packet) from the transmission portion. The control portion data receiving server 2 may be managed by an electric power company or managed by an Internet service provider which is completely irrelevant to control of electric power.

The power quantity receiving server 3 receives data (packet) from the transmission portion. The power quantity receiving server 3 is located in a substation managed by the electric power company or located in an MDMS (Meter Data Management System) installed in a relay point of the data. The power quantity receiving server 3 monitors the operation of each smart meter 1.

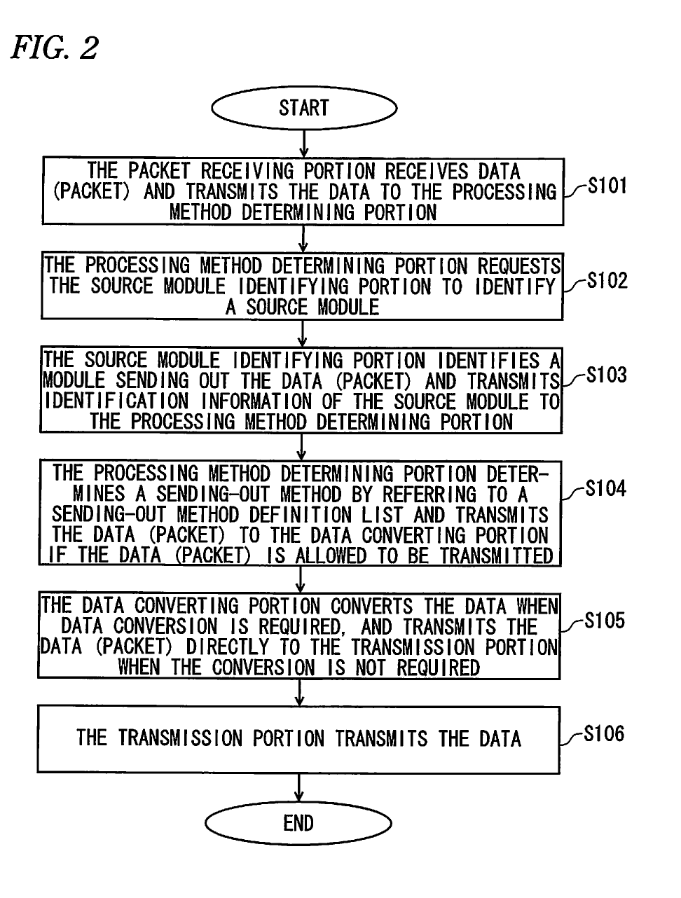

The outline of the operation of the embodiment will be described with reference to FIG. 2. The packet receiving portion 111 receives data (packet) and transmits the received data (packet) to the processing method determining portion 112 (S101).

The processing method determining portion 112 requests the source module identifying portion 114 to identify a source module (S102).

The source module identifying portion 114 identifies the module sending out the data (packet) and transmits identification information of the source module to the processing method determining portion 112 (S103).

The processing method determining portion 112 determines a processing method for the data (packet) by use of the identification information of the source module and the sending-out method definition list stored in the sending-out method definition list storage portion 113, and transmits the data (packet) to the data converting portion if the data (packet) is allowed to be transmitted (S104).

The data converting portion 115 converts the data (packet) when the conversion is required, or transmits the data (packet) directly to the transmission portion 116 when the conversion is not required (S105).

The data transmitting portion transmits the data (packet) to the outside of the smart meter (S106).

According to the embodiment, it is possible to provide a network device authentication method so that security of the network device in which functions having different rights are mixed can be kept high without any complication.

### Second Embodiment

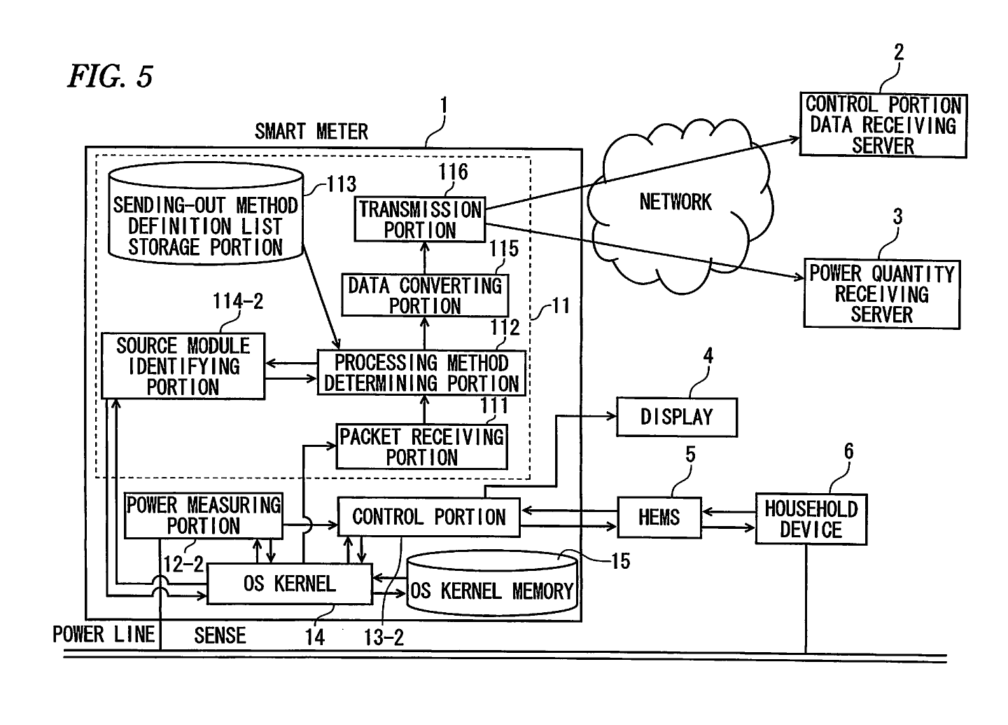

An example of the embodiment will be described below with reference to FIG. 5.

Description about functions the same as those in the aforementioned embodiment will be omitted here. Therefore, description will be made mainly on an OS kernel 14, an OS kernel memory 15, a source module identifying portion 114-2, a power measuring portion 12-2 and a control portion 13-2 which are different from FIG. 1.

Although the OS kernel 14 may be conceived as a general operating system (OS) for performing process management, the OS kernel 14 may be provided simply as a computer program for changing a library function to another in accordance with an implementation method.

The OS kernel 14 manages respective operating modules. Further, information of a packet which each module requests the OS kernel to transmit to the packet receiving portion is also held in the kernel memory. Therefore, the OS kernel 14 can find which module requests the OS kernel to send out the packet, by referring to the information in the kernel memory.

In the embodiment, the OS kernel 14 obtains information from the power measuring portion 12-2 or the control portion 13-2. Specifically, the OS kernel 14 manages each module operating in the power measuring portion 12-2 or the control portion 13-2, and holds information of data (packet) transmitted by the module in the kernel memory. In addition, the OS kernel 14 may transmit some information to the power measuring portion 12-2 or the control portion 13-2.

The power measuring portion 12-2 is provided so that each module operating in the power measuring portion 12-2 requests the OS kernel 14 to transmit data (packet) to the packet receiving portion 111. The OS kernel 14 transmits the requested data (packet) to the packet receiving portion 111. In addition, the OS kernel 14 stores identification information of the requesting module of the power measuring portion 12-2 and the transmitted data (packet) in association with each other in the kernel memory 15. The control portion 13-2 is provided so that each module operating in the control portion 13-2 requests the OS kernel 14 to transmit data (packet) to the packet receiving portion 111. In addition, the OS kernel 14 stores identification information of the requesting module of the control portion 13-2 and the transmitted data (packet) in association with each other in the kernel memory 15.

The OS kernel memory 15 stores information of the packet transmitted by each module for a predetermined period of time. Specifically, the OS kernel memory 15 stores information of the data (packet) which is being transmitted by each module operating in the power measuring portion 12-2 or the control portion 13-2 in response to the transmission request given to the OS kernel 14. This is because the information of the packet needs to be held up to completion of communication even after transmission of the packet for the purpose of TCP session management, etc. as an ordinary OS mechanism. The information of the packet is held at least while the packet is transmitted from the smart meter to the outside. Incidentally, the ordinary OS mechanism is used with respect to the timing when the information of the packet stored in the OS kernel memory 15 should be deleted, so that detailed description thereof will be omitted.

Upon reception of data (packet) from the processing method determining portion 112, the source module identifying portion 114-2 identifies identification information of a source module by referring to the information stored in the OS kernel memory 15. The source module identifying portion 114-2 transmits the identification information of the source module to the processing method determining portion. For example, the identification information of the source module is broadly used under the name of netstat command, ps command, proc file system, etc. Further, commands (TCPView, etc. for Windows (registered trademark)) obtained by shaping these to make clearly understandable to the user are also used. Upon reception of the data (packet) from the processing method determining portion 112, the source module identifying portion 114-2 may send out identification information etc. of the data (packet) to the OS kernel 14 so that the OS kernel 14 extracts identification information of a source module corresponding to the identification information of the received data (packet) and sends out the extracted identification information of the source module to the source module identifying portion 114-2.

### Third Embodiment

Although the aforementioned embodiment is configured so that the smart meter 1 is composed of functional modules (program libraries) managed by one OS kernel 14-3, it is a matter of course that any design can be used for the implementation mode of the OS kernel 14-3 etc.

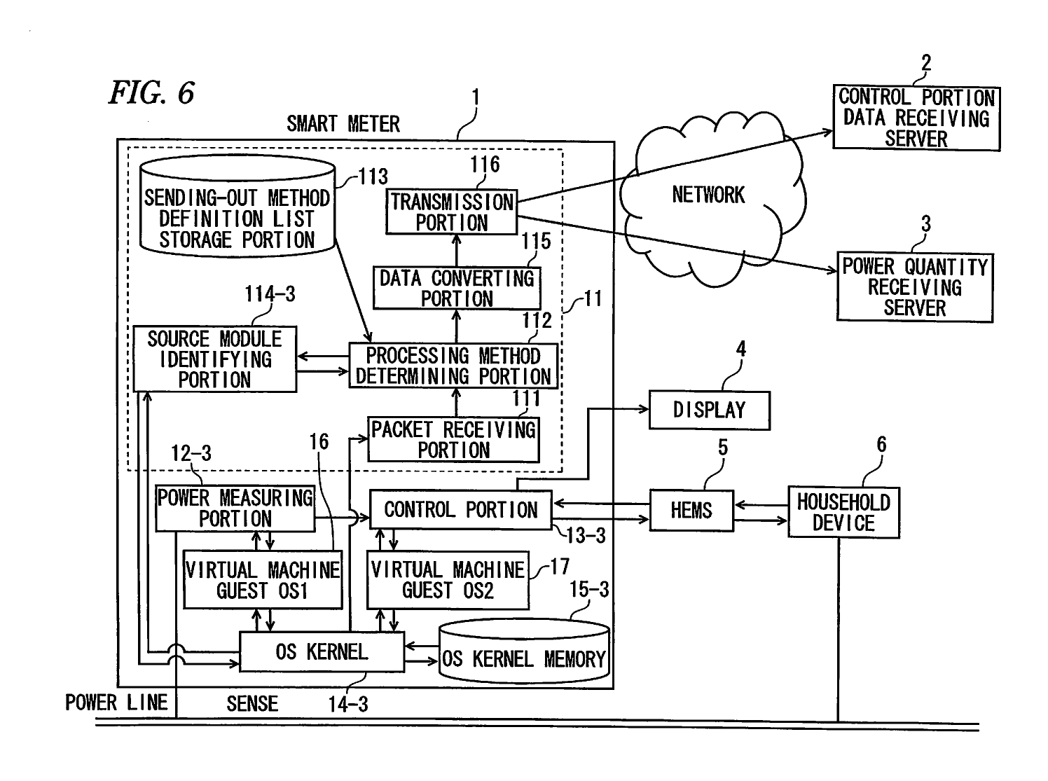

The embodiment will be described in the case where the smart meter 1 is formed by virtual machine technology as shown in FIG. 6. The virtual machine technology is technology which can operate plural OS's on one computer simultaneously and handle the OS's as if the OS's were one program. VMware, Virtual PC, Xen, etc. are broadly used as examples of software implementing the virtual machine technology.

In the configuration example using the virtual machine technology, the smart meter 1 is managed by a virtual machine host. The virtual machine host may be also called host OS. The OS to be operated here is called guest OS. In the example of FIG. 6, a virtual machine guest OS (1) 16 and a virtual machine guest OS (2) 17 are operating. The guest OS's may be of the same kind or of different kinds. For example, one of the guest OS's is Windows (registered trademark) OS while the other is Linux OS.

In such a configuration, the virtual machine guest OS's are formed so that a specific module provided in accordance with each virtual machine guest OS requests the virtual machine guest OS to transmit data (packet) to the packet receiving portion 111. The virtual machine guest OS transmits the accepted request and the data (packet) to the OS kernel 14-3.

For example, the virtual machine guest OS (1) 16 obtains data (packet) from a power measuring portion 12-3 and a request for transmission to the packet receiving portion 111, and transmits the obtained data (packet) and the obtained request for transmission to the packet receiving portion 111 to the OS kernel 14-3. The virtual machine guest OS (2) 17 obtains data (packet) from a control portion 13-3 and a request for transmission to the packet receiving portion 111, and transmits the obtained data (packet) and the obtained request for transmission to the packet receiving portion 111 to the OS kernel 19-3. In addition, the power measuring portion 12-3 may transmit information to the virtual machine guest OS (1) 16 while the control portion 13-3 may transmit information to the virtual machine guest OS (2) 17.

The OS kernel 14-3 receives the data (packet) and the request for transmission to the packet receiving portion 111 from the virtual machine guest OS (1) 16 or the virtual machine guest OS (2) 17. The OS kernel 14-3 then transmits the received data (packet) to the packet receiving portion 111. In addition, the OS kernel 14-3 stores information about correspondence between identification information of each virtual machine guest OS and the data (packet) received from the virtual machine guest OS in the OS kernel memory 15-3. In addition, in accordance with necessity, the OS kernel 14-3 reads the information about correspondence between the identification information of each virtual machine guest OS and the data (packet) received from the virtual machine guest OS. In addition, in accordance with a request from a source module identifying portion 114-3, the OS kernel 14-3 sends out the read information to the source module identifying portion 114-3 or identifies the virtual machine guest OS receiving the data (packet) and sends out the identification information of the identified virtual machine guest OS to the source module identifying portion 114-3.

Although the example shows the case where the OS kernel transmits the data (packet) to the packet receiving portion 111, each virtual machine guest OS may transmit data (packet) to the packet receiving portion 111.

In the smart meter 1 configured as described above, sending-out methods defined in accordance with the virtual machine guest OS's respectively are described in a sending-out method definition list, and the processing method determining portion 112 determines a processing method for transmission data by using guest OS information identified by the source module identifying portion 114-3 so that data can be transmitted in accordance with the function assigned to each guest OS. Accordingly, for example, in the smart meter 1 having mixed guest OS's largely different in terms of required security, suitable access control can be achieved without implementation of complicated authentication mechanisms individually. Particularly, even when an OS with danger of infection with a computer virus is used as each guest OS for an implementation reason, operation failure due to the virus is restricted to the guest OS and a server with which the guest OS communicates, so that it is possible to prevent a bad influence from being given to the other guest OS and a server with which the other guest OS communicates.

### Fourth Embodiment

The embodiment will be described in the case where the data converting portion 115 adds module type information identified by the source module identifying portion 114, 114-2 or 114-3 to data by way of example. Parts other than the data converting portion and the sending-out method definition list are common with those in the aforementioned embodiments so that description thereof will be omitted here. In addition, the data converting portion is different but the overall configuration is the same as in FIGS. 1, 4 and 5 so that illustration of the overall configuration will be also omitted.

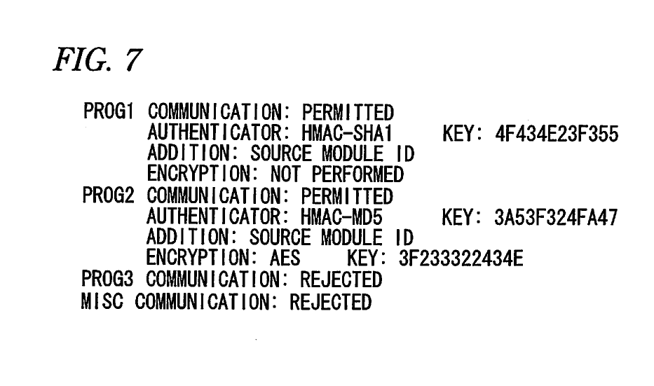

An instruction to add source module identification information (hereinafter referred to as source module ID) for identifying a source module is added to a sending-out method definition list stored in the sending-out method definition list storage portion according to the embodiment. For example, FIG. 7 shows an example of the sending-out method definition list according to the embodiment. The sending-out method definition list will be described with reference to FIG. 7. Although FIG. 3 shows the case where an instruction to add an authenticator hmac-sha1 is provided in Prog1, FIG. 7 shows the case where an instruction to add a source module ID of the module Prog1 and further calculate an authenticator hmac-sha1 in addition to the aforementioned instruction is added in Prog1. The same thing applies to Prog2.

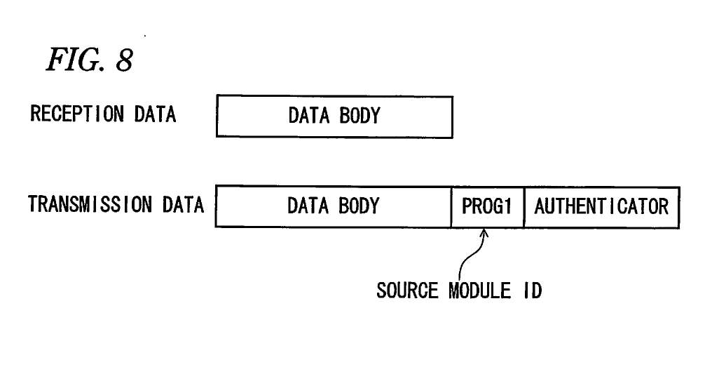

As shown in FIG. 8, the data converting portion adds a source module ID to original data, and further calculates and adds an authenticator hmac-sha1 thereto because an instruction to add the source module identification information for identifying the source module is added in the sending-out method definition list.

Since the authenticator is added, there is no fear that the source module ID will be falsified on the network even in the case where the data is not encrypted.

In this manner, information indicating which program module in the smart meter created the data sent out from the smart meter 1 can be transmitted to a serving receiving the data safely. Accordingly, the packet sending-out method is not defined fixedly based on the information of only the sending-out method definition list, but the server receiving the data can determine permission/prohibition of communication flexibly in accordance with the server's policy while also referring to the source module ID. Thus, more flexible access control can be achieved.

To achieve this in the related art, a large number of authentication mechanisms corresponding to the number of modules to be subjected to authentication need to be implemented troublesomely for authentication of only one smart meter 1. However, according to the embodiment, the same effect as that achieved by individual authentication can be obtained by a simple operation of comparing the ID of the source module Prog1, so that simple implementation can be made.

### Fifth Embodiment

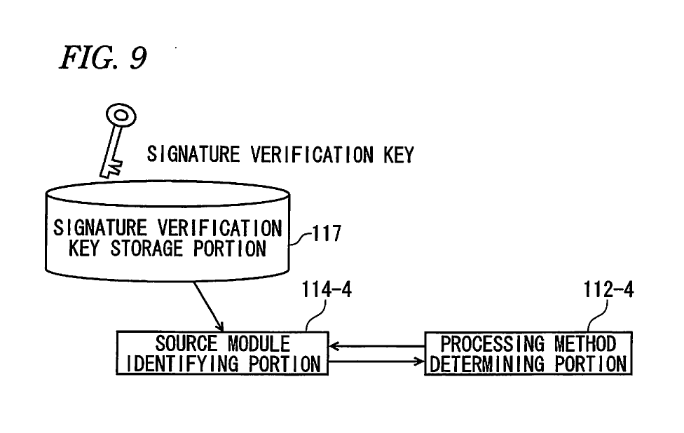

The embodiment will be described with reference to FIG. 9 in the case in which a digital signature (or an authenticator or check sum) of software of a identified module can be verified as another method for implementing the source module identifying portion. As shown in FIG. 9, in the embodiment, a digital signature of module data is in advance added to data (packet) sent out by a source module which needs to be identified, so that the digital signature is verified with a signature verification key.

In FIG. 9, parts other than a source module identifying portion, a processing method determining portion and a signature verification key storage portion are the same as those in the aforementioned embodiments, so that the parts are omitted here but can be combined with any of the aforementioned embodiments.

A processing method determining portion 112-4 receives digital signature-including data (packet) received by a packet receiving portion 111-4 (not shown) and transmitted to a processing method determining portion 112-4 by the packet receiving portion 111-4. The processing method determining portion 112-4 verifies the received data (packet) with a signature verification key to check whether the signature is valid or not.

Determination may be made that a module added with a valid signature is valid. More accurately, implementation may be made in such a manner that a digital signature including a program name or the like is added in advance so that determination can be made that the source module is valid when the program name is checked to be valid.

In addition, by use of this method, it is not necessary to refer to information (the kernel memory 15 or 15-3) managed by the OS in identifying the source module. Since reference to the information managed by the OS may involve difficulty due to the nature of the OS, there are some cases in which the method according to the embodiment is superior.

Although a technique called digital signature often means a signature using an ordinary public key encryption method, any signature may be used here as long as the signature is provided as an electronic signature. For example, the case where an authenticator is added or a simple check sum is added by way of precaution may be conceived. The signature method is not limited particularly.

In the case where, for example, a source module which can be identified by the OS is a path name of a program, it is impossible to find out change (falsification) of contents of the program due to a malicious program or the like without change of the path name, but use of the embodiment can prevent a mistaken operation.

### Sixth Embodiment

The embodiment will be described in the case where a source module identifying portion identifies detailed information indicating how software of a identified module has been started up. Since the system configuration is the same as that in any one of the aforementioned embodiments, illustration of the system configuration will be omitted here. Modifications of the source module identifying portion 114, 114-2, 114-3 or 114-4 and the processing determining portion 112 shown in FIGS. 1, 5 and 6 will be described while the other constituent members are the same.

The background as to why such a function is necessary will be described below. Generally, as to programs managed by an OS, it is rarely that one function is implemented by one single program. In most cases, one function is implemented in such a flow that a child process is started up from a parent process and a grandchild process is further started up from the child process. Accordingly, there may be conceived a case in which satisfactory security cannot be ensured when access control is simply performed based on only the name of one program.

When, for example, a program D usually started up in a sequence of programs A→B→C→D is valid, a program D′ started up in a sequence of programs E→D′ may be also regarded as valid if the source module identifying portion identifies only one source module.

However, when a program is started up in such an unexpected sequence, there is an extremely high possibility that an unsafe situation will occur. For example, assuming that the program E is a server which receives e-mails from a network, then it may be conceived that the program D is executed illegally under the right (administrator's right etc.) of the program E because the right of execution is hijacked by illegal intrusion into the server.

Therefore, detailed information indicating how software of a identified module has been started up is identified.

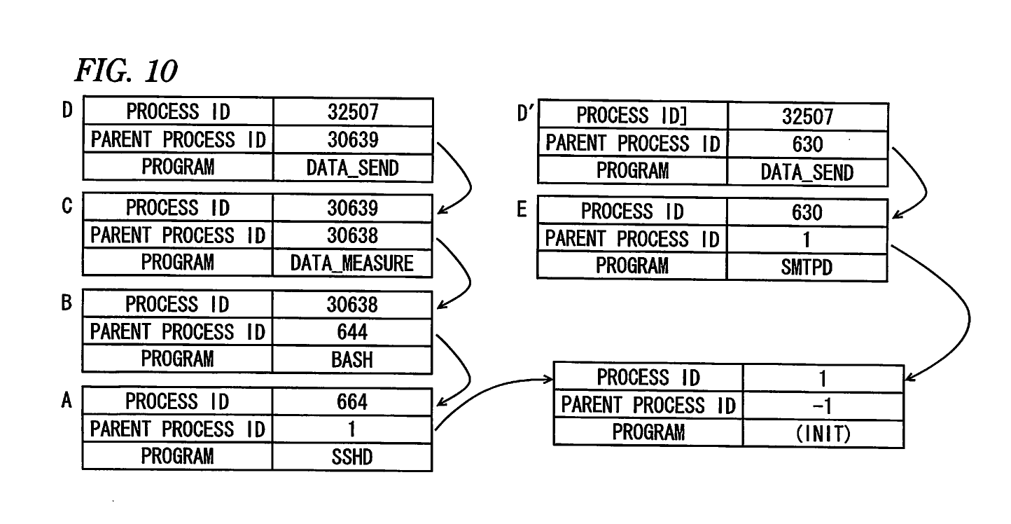

In order to identify the detailed information, the OS kernel 14 or 14-3 grasps correspondence among each program (program module), identification information (process ID) of a process executed by the program, and identification information (parent process ID) of a parent process of the process. The information about the correspondence is referred to as process table. FIG. 10 shows an example of the process table.

For example, the example of FIG. 10 shows the case where programs are started up in a sequence A (sshd)→B (bash)→C(Data_Measure)→D(Data_send). The OS kernel 14 or 14-3 initially starts up a program (init). Then, the OS kernel 14 or 14-3 grasps correspondence among the program (init), a parent process ID “-1” (because there is no parent process) and a process ID “1”.

Then, a program A (sshd) is started up. Then, since the parent process ID of the program A (with program identification information “sshd”) is “1” and the process ID of the program A is “664”, the OS kernel 14 or 14-3 grasps correspondence among the program identification information “sshd”, the parent process ID “1” and the process ID “664”.

Then, a program B (bash) is started up. Then, since the parent process ID of the program B (with program identification information “bash”) is “664” and the process ID of the program B is “30638”, the OS kernel 14 or 14-3 grasps correspondence among the program identification information “bash”, the parent process ID “664” and the process ID “30638”.

Then, a program C (Data-Measure) is started up. Then, since the parent process ID of the program C (with program identification information “Data_Measure”) is “30638” and the process ID of the program C is “30639”, the OS kernel 14 or 14-3 grasps correspondence among the program identification information “Data-Measure”, the parent process ID “30638” and the process ID “30639”.

Further, a program D (Data-send) is started up. Then, since the parent process ID of the program D (with program identification information “Data_send”) is “30639” and the process ID of the program D is “32507”, the OS kernel 14 or 14-3 grasps correspondence among the program identification information “Data-send”, the parent process ID “30639” and the process ID “32507”. In this manner, the parent process ID's can be referred to by using the process tables managed by the OS kernel 14 or 14-3 so that the parent processes can be traced in order.

When the source module identifying portion 114, 114-2, 114-3 or 114-4 identifies a source module as in the aforementioned embodiments and examples, the source module identifying portion 114, 114-2, 114-3 or 114-4 requests the OS kernel 14 or 14-3 to obtain the process tables managed by the OS kernel 14 or 14-3. By use of the obtained process tables, the source module identifying portion 114, 114-2, 114-3 or 114-4 refers to the parent process ID of the identified module to extract program start-up relation information which is information as to which program is started up from which program. The source module identifying portion 114, 114-2, 114-3 or 114-4 transmits the program start-up relation information to the processing method determining portion.

The processing method determining portion 112 identifies a program which is last started up in the program start-up relation information received from the source module identifying portion, and obtains a processing method definition list concerned with the identified program from the sending-out method definition list storage portion. Based on the obtained processing method definition list and the program start-up relation information, the processing method determining portion 112 determines whether starting-up is performed from a valid program or not. When conclusion is made that starting-up is performed from an invalid program, the processing method determining portion stops sending-out of data (packet).

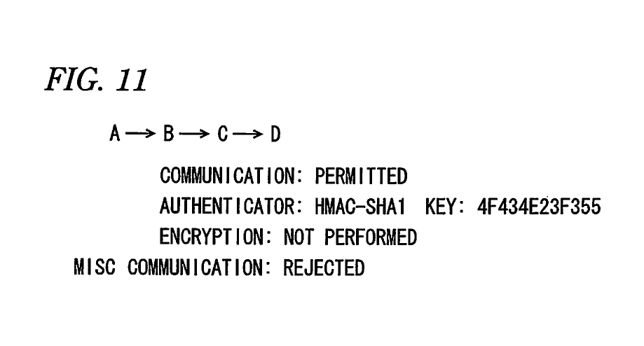

FIG. 11 shows an example of a sending-out method definition list according to the embodiment. The processing method determining portion 112 reads a sending-out method definition list from the sending-out method definition list storage portion 113. If processes are started up in a sequence A→B→C→D, the processing method determining portion 112 sends out a message indicating permission of communication, data (packet) and a message indicating transmission without encryption after creation of an authenticator based on a key shown in FIG. 11 and an hmac-sha1 algorithm, to the data converting portion 115.

According to the embodiment, in a network device in which mixed functions having different rights are mixed, an authentication function to be executed can be implemented while different rights are distinguished from one another without independent authentication functions given to the mixed functions respectively.

Because it is unnecessary to implement authentication mechanisms in accordance with modules, implementation becomes so simple that malfunction (bugs) of programming can be prevented from occurring and that the required memory capacity can be minimized. In addition, because key management can be unified for the whole device, the procedure thereof can be simplified.

Even if a defective module implemented invalidly is contained in the device in spite of unification of the key management, the influence can be limited to the function of the defective module to prevent the security of the whole system from being lowered. Moreover, since it is unnecessary to manage a secret key in accordance with each module, there is no risk that the key will be leaked or mistaken data transmission will be performed because the secret key irrelevant to other modules comes into view from the other modules.

Even when future decryption technology makes progress, replacement of the authentication function can be performed easily to improve security without any enormous confirmation work for complete replacement of authentication modules because the authentication modules are unified. Accordingly, the embodiment is also advantageous in terms of system maintenance.

According to the embodiment, for example, application to the following scene can be conceived.

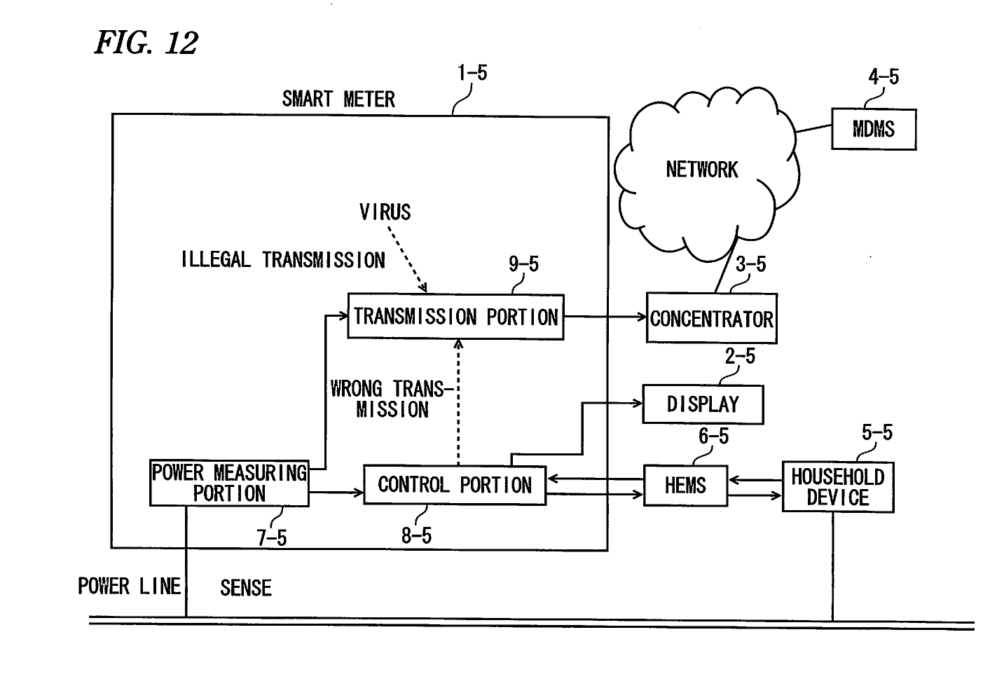

FIG. 12 illustrates an application example of the embodiments. For example, in a power monitoring network (next-generation power network) called “smart grid”, a monitoring terminal (smart meter 1-5) placed in an end user (ordinary home, etc.) performs data communication which is important and requires security in order to transmit a power demand/supply forecast to a substation. At the same time, the monitoring terminal (smart meter) may operate various applications, such as display of power utilization status on a display 2-5 and control of a household device such as an air conditioner, these various applications being complicated to cause program malfunction easily. In addition, the monitor terminal (smart meter) may be operated based on data received from an external application causing program malfunction easily. Thus, there is a fear that security of the device as a whole may be spoiled.

When the smart meter 1-5 having this kind of complicated function is implemented by the device authentication method (A) according to the related art, data measured by a power measuring portion connected to a power line is transmitted by the smart meter 1-5 to a substation of a smart grid, an MDMS (Metering Data Management System) 4-5, etc. via a concentrator 3-5, etc. located in a remote place. On this occasion, authentication processing (addition of an authenticator, encryption, etc.) is performed by a transmission portion 9-5 so that secure communication is performed. Communication data from the smart meter 1-5 always passes through the transmission portion 9-5 so that authentication processing is performed surely by the transmission portion 9-5.

However, a control portion 8-5 in the smart meter 1-5 is a huge application which performs a display function on the display 2-5, data exchange with an HEMS (Home Energy Management System: home server) 6-5 which works with a household device 5-5, etc. Therefore, the transmission portion 9-5 may often perform wrong transmission by mistake due to wrong data processing, wrong data received from the HEMS 6-5, etc. In this case, because the transmission portion 9-5 cannot usually determine whether it is wrong transmission or not, the transmission portion 9-5 transmits the wrong data directly to the communication network of the smart grid. Thus, there is a possibility that this wrong data transmission will cause confusion of a local power transmission and distribution system and will cause a problem of power failure or the like when things come to the worst. Similarly, there is a fear that the power transmission and distribution system will be confused because a computer virus illegally invading the smart meter 1-5 for some reason sends illegal data to the transmission portion 9-5 or an outside attacker sends illegal data to the transmission portion 9-5 through the network.

On the other hand, when the smart meter 1-5 is implemented by the module authentication method (B) according to the related art, a power measuring portion 7-5 has an authentication function uniquely and communicates with the MDMS 4-5 through the smart grid network while adding an authenticator based on a secret key. The MDMS 4-5 verifies the authenticator based on the same secret key as that of the power measuring portion 7-5. On the other hand, the control portion 8-5 has an authentication function separately and transmits complicated data for household device control etc. to an ASP (Application Service Provider). The MDMS 4-5 and the ASP have different roles and have unique authentication functions and secret keys individually. Therefore, there occurs no accident that, for example, the control portion 8-5 transmits invalid data created by mistake to the MDMS 4-5 to thereby confuse the power transmission and distribution network.

However, separation of authentication methods from one another in accordance with access subjects has a merit of enhancing security but has various demerits at the same time.

First, since authentication mechanisms have to be implemented in accordance with the respective modules, the implementation becomes complicated, malfunction (bugs) of programming occurs easily, the required memory capacity becomes large, or the procedure of key management becomes complicated. Moreover, even when there is only one module implemented incorrectly, the system security as a whole is lowered. Moreover, since a secret key according to each module is not particularly safeguarded in the device, the secret key irrelevant to other modules comes into view from the other modules so that it is impossible to eliminate the risk that the key will be leaked or mistaken data transmission will be performed. In addition, even when future decryption technology makes progress, each authentication module has to be replaced. However, when a large number of authentication modules are incorporated complicatedly, enormous confirmation work occurs for complete replacement of the authentication modules. That is, this implementation method is not preferred because it takes a lot of time and labor and it is difficult to maintain security at the same time.

In a network device authentication device according to the related art, for authentication of a device having a complicated use mode in accordance with the popularization of a communication network, when functions having different rights are mixed, misinformation transmitted from the transmission portion 9-5 because of mistaken data processing, etc. in an application may hinder the original authentication function from working effectively or it is difficult to prevent an illegally invading computer virus from sending illegal data into the transmission portion 9-5.

On the other hand, when an independent authentication function is provided for each function, implementation will become complicated, malfunction (bugs) of programming will occur easily, or the procedure of key management will become complicated. Thus, there is a problem that it is difficult to maintain the system security.

Each embodiment can provide a network device authentication method for safely implementing a network device in which functions having different rights with a very simple procedure.

Although the respective embodiments have been described in the case where a key required for creation of an authenticator and encryption is stored in the sending-out method definition list storage portion, the configuration of the sending-out method definition list is not limited thereto. For example, there can be conceived another form in which the data converting portion holds key information and (not the key information per se but) only an index number indicating the key to be used is described in the sending-out method definition list.

Incidentally, the method described in each of the embodiments may be stored and distributed, as a program which can make a computer execute the method, in a storage medium such as a magnetic disk (a floppy (registered trademark) disk, a hard disk etc.), an optical disk (CD-ROM, DVD, etc.), a magneto-optical disk (MO) or a semiconductor memory.

In addition, the storage medium may take any storage format as long as the storage medium can store a program and the program can be read from the storage medium by the computer.

An OS (Operating System), MW (MiddleWare) such as database management software and network software, etc. operating on the computer may execute part of each process for achieving each of the embodiments, based on an instruction given from the program installed in the computer through the storage medium.

In the embodiment, the storage medium is not limited to a medium independent of a computer, but may include a storage medium in which a program transmitted through an LAN, the Internet, etc. is downloaded and stored or temporarily stored.

In addition, the number of storage media is not limited to one. When processing in each of the embodiments is executed through plural media, these media are also included in the storage medium in the embodiment and any configuration may be used as the medium configuration.

In the embodiment, the computer is a device which executes each process in each of the embodiments based on a program stored in the storage medium. The computer in the embodiment may have any configuration. For example, the computer in the embodiment may be a single device such as a computer or may be a system or the like composed of plural devices connected on a network.

In the embodiment, the computer is not limited to a personal computer but may include a processor or a microcomputer included in an information processing apparatus. The computer in the embodiment is simply a generic term for an apparatus or device in which the function of the embodiment can be implemented by a program.

Although some embodiments have been described, these embodiments are presented by way of example but have no intention of limiting the scope of the invention. These new embodiments may be carried out in other various modes and can be omitted, replaced or changed variously without departing from the scope of the invention. Not only the embodiments and their modifications but also their equivalents fall within the scope of Claims.

1. A data transmission processing device, comprising:
a data receiving portion configured to receive data;
a source module identifying portion configured to identify a module having sent out the data;
a sending-out method definition list storage portion configured to store a sending-out method definition list defined in accordance with each source module and indicating a processing method for the data, the processing method including a data conversion method or permission/prohibition of communication;
a processing method determining portion configured to determine a processing method corresponding to the source module identified by the source module identifying portion by referring to the sending-out method definition list;
a data converting portion configured to convert the data when the data conversion method is included in the processing method determined by the processing method determining portion; and
a transmission portion configured to send out the data or the converted data when the processing method determining portion concludes that communication is permitted.

2. The device of claim 1,
wherein the data converting portion adds identification information of the module identified by the source module identifying portion to the data.

3. The device of claim 2,
wherein the data receiving portion further receives a digital signature or an authenticator or check sum of the module having sent out the data, and
wherein the source module identifying portion verifies the digital signature or the authenticator or check sum of the identified module to confirm whether the module is valid or not.

4. The device of claim 3,
wherein the source module identifying portion detects detailed information indicating how the identified module has been started up.

5. A data transmission program for enabling a computer to implement a system, the system comprising:
a data receiving portion configured to receive data;
a source module identifying portion configured to identify a module having sent out the data;
a sending-out method definition list storage portion configured to store a sending-out method definition list defined in accordance with each source module and indicating a processing method for the data, the processing method including a data conversion method or permission/prohibition of communication;
a processing method determining portion configured to determine a processing method corresponding to the source module identified by the source module identifying portion by referring to the sending-out method definition list;
a data converting portion configured to convert the data when the data conversion method is included in the processing method determined by the processing method determining portion; and
a transmission portion configured to send out the data or the converted data when the processing method determining portion concludes that communication is permitted.
